(19) United States
(12) Patent Application Publication
(10) Pub. No.: US 2008/0165327 A1
(43) Pub. Date: Jul. 10, 2008

(54) LIGHT SOURCE DEVICE AND IMAGE DISPLAY DEVICE

(75) Inventor: Kunihiko TAKAGI, Okaya-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 11/851,472

(22) Filed: Sep. 7, 2007

(30) Foreign Application Priority Data
Oct. 19, 2006 (JP) 2006-284815
Jul. 4, 2007 (JP) 2007-175878

(51) Int. Cl. H01S 3/098; G03B 21/00

(52) U.S. Cl. 353/85; 372/19

(57) ABSTRACT

A light source device includes a light emitting section having at least one light emitting element for emitting a laser beam perpendicularly to an emission surface in laser oscillation, an external resonator for selectively returning light with a specific wavelength to the light emitting element, thereby causing the laser oscillation of the light emitting element with the specific wavelength, a base plate to which the light emitting section and the external resonator are fixed, and an optical element disposed and fixed on a light path of the laser beam between the light emitting element and the external resonator and distantly from the surface of the light emitting element, and for changing a proceeding direction of the laser beam.

### BACKGROUND

1. Technical Field

The present invention relates to a light source device and an image display device.

2. Related Art

In recent years, in an opto-electronics field such as optical communications, optical application measurement, or optical displays, laser source devices, which use an oscillation beam from a semiconductor laser source after converting the frequency thereof, have widely been used. As the laser source device described above, there has been proposed an external resonance laser, which is provided with a semiconductor laser element and an external resonator, causes laser oscillation in the semiconductor laser element to emit light with a specific wavelength by the external resonator selectively feeding back the light with the specific wavelength to the semiconductor laser element, and provides a laser beam transmitted through the external resonator for applications, thereby stably supplying the laser beam with a narrow wavelength band (see, e.g., JP-T-2006-511966 (the term “JP-T” as used herein means a published Japanese translation of a PCT patent application)).

However, the external resonance laser described in the above document and shown in FIG. 7, for example, requires a protruding section or an L-shaped member provided with an external resonant mirror holding surface extending from a surface provided with a laser chip 301 (303) to above the laser chip 301 (303) in order for holding an external resonant mirror 307.

In particular, in the case with a laser structure in which a wavelength conversion element is inserted between the laser chip 301 (303) and the external resonant mirror 307, the external resonant mirror holding surface needs to be distant from the laser chip 301 (303) the length of the wavelength conversion element further, and accordingly, the dimension of the protruding section from the surface on which the laser chip is disposed to the external resonant mirror holding surface becomes larger. In addition, in the case of a laser array chip, the external resonant mirror 307 is required to nave a width greater than the length of the chip in the array direction, and accordingly, the protruding section forming the external resonant mirror holding surface is also required to have a large width. As a material of a member 305 to which the laser chip 301 (303) is provided, metal with a good heat conductivity such as copper is generally used in order for radiating the heat from the laser chip 301 (303).

Specifically, the metal member with the protruding section or the L-shaped metal member, having a long and thick protruding section is manufactured by die-casting or metallic powder injection molding (MIM), which increases the cost. Further, in the case of forming the condition by combining two bodies, the process of joining the two bodies is required, thus the work becomes troublesome, and the cost becomes much higher. Still further, a space for providing the long and thick protruding section or the L-shaped member is required, and accordingly, sufficient downsizing (low-profiling) could have not achieved.

### SUMMARY

Some aspects of the invention have an advantage of solving at least a part of the problem described above, and can be embodied as following aspects or application examples.

According to a first aspect of the invention, there is provided a light source device including a light emitting section having at least one light emitting element for emitting a laser beam perpendicularly to an emission surface in laser oscillation, an external resonator for selectively returning light with a specific wavelength to the light emitting element, thereby causing the laser oscillation of the light emitting element with the specific wavelength, a base plate to which the light emitting section and the external resonator are fixed, and an optical element disposed and fixed on a light path of the laser beam between the light emitting element and the external resonator and distantly from the surface of the light emitting element, and for changing a proceeding direction of the laser beam.

According to the first aspect of the invention, by using the optical element, the long and thick protruding section or the L-shaped member can be eliminated. Further, since the light emitting section, the optical element, and the external resonator can be disposed and fixed on the base plate from the same directions, it is superior in workability in the manufacturing process, thus the cycle time of the manufacturing process can be reduced. Thus, the cost reduction can be realized while simplifying the device configuration, ana further, downsizing can also be realized.

According to a second aspect of the invention, in the light source device described above, the optical element changes the proceeding direction of the laser beam entering the optical element as much as about 90 degrees.

Accordingly, it becomes easy to dispose and fix the light emitting section, the optical element, and the external resonator on the base plate.

According to a third aspect of the invention, the light source device described above further includes a wavelength conversion element on the light path of the laser beam between the optical element and the external resonator, wherein the wavelength conversion element is disposed and fixed on the base plate and converts the wavelength of the laser beam which has passed through the optical element.

Accordingly, in the configuration for performing the wavelength conversion, by the external resonator folding the light beam before the wavelength conversion to be recursively transmitted through the wavelength conversion element, the wavelength conversion can be performed without any loss, thus the conversion efficiency of the wavelength conversion element can be improved.

According to a fourth aspect of the invention, in the light source device described above, the optical element is provided with a polarization-dependent optical film in the light path of the laser beam, the polarization-dependent optical film having a characteristic different in one of reflectance and transmittance representing a ratio of the laser beam emitted to the wavelength conversion element to the laser beam entering from the light emitting element, between two polarization components if the laser beam having different polarization directions.

Accordingly, the laser beam aligned in the polarization direction can be obtained, and accordingly, the efficiency of the light can be improved when the light source is used in combination with the polarization controlling device such as a liquid crystal device.

According to a fifth aspect of the invention, in the light source device described above, the polarization direction in which one of the reflectance and the transmittance of the polarization-dependent optical film is higher is substantially the same as the polarization direction of the wave length element.

Accordingly, by causing the laser oscillation only in the polarized light having the polarization direction in which the wavelength conversion element provides high conversion efficiency, thus the conversion efficiency of the wavelength conversion element can be improved.

According to a sixth aspect of the invention, in the light source device described above, the optical element is a mirror having a reflection surface for reflecting at least light with the wavelength of the laser beam.

Accordingly, it becomes possible to realize the effective change in the proceeding direction of the laser beam at a low cost,

According to a seventh aspect of the invention, in the light source device described above, the optical element is a prism.

Accordingly, it becomes possible to realize the effective change in the proceeding direction of the laser beam at a low cost.

According to an eighth aspect of the invention, in the light source device described above, the prism is a rectangular prism having a cross-section of an isosceles right triangle, a surface of the rectangular prism including a long side of the isosceles right triangle cross-section is a reflection surface for reflecting laser beams entering surfaces of the rectangular prism respectively including the rest of the sides in a substantially perpendicular manner, and a part of the surface of the rectangular prism including one of the rest of the sides is disposed and fixed to the base plate via a spacer section.

Accordingly, it becomes easy to dispose and fix the light emitting section, the optical element, and the external resonator on the base plate.

According to a ninth aspect of the invention, in the light source device described above, a surface of the prism on which the spacer section is disposed is provided with a reflection reducing film for reducing reflection of the laser beam when the laser beam one of emitted and reflected by the light emitting element enters the prism.

Accordingly, by reducing the reflection of the prism surface existing adjacent to the light emitting element, the laser oscillation of the light emitting element and the external resonator can be stabilized.

According to a tenth aspect of the invention, in the light source device described above, the polarization-dependent optical film is further provided with a wavelength separation function for reflecting a laser beam with a wavelength converted by the wavelength conversion element towards the external resonator when the laser beam with the wavelength converted by the wavelength conversion element enters from a side the external resonator in the case in which the polarization-dependent optical film is provided to a surface of the rectangular prism including one of the rest of the sides other than the reflection surface and the spacer section disposing surface of the prism.

Accordingly, in the configuration of performing the wavelength conversion, by folding the laser beam by the prism, having the wavelength converted by the wavelength conversion element, the wavelength-converted laser beam can be taken out through the wavelength conversion element and the external resonator without returning the wavelength-converted laser beam to the light emitting element, the wavelength conversion can be performed without any loss.

According to an eleventh aspect of the invention, the light source device described above further includes a positioning section, for positioning the optical element and the external resonator with respect to the position of the light emitting element of the light emitting section.

Accordingly, the effective positioning can easily be realized.

According to a twelfth aspect of the invention, in the light source device described above, the positioning section is a pin.

Accordingly, it becomes possible to realize the effective positioning at a low cost.

According to a thirteenth aspect of the invention, there is provided an image display device including either one of the light source devices described above, an optical modulation device for modulating light emitted from the light source device in accordance with an image signal, and a projection device for projecting the image formed by the optical modulation device.

According to the first aspect of the invention, by using the optical element, the long and thick protruding section or the L-shaped member can be eliminated. Further, since the light emitting section, the optical element, and the external resonator can be disposed and fixed on the base plate from the same directions, it is superior in workability in the manufacturing process, thus the cycle time of the manufacturing process can be reduced. Thus, the cost reduction can be realized while simplifying the device configuration, and further, downsizing can also be realized.

According to a fourteenth aspect of the invention, there is provided an image display device including either one of the light source devices described above, and a scanning section for scanning a projection target surface with a laser beam emitted from the light source device.

According to the first aspect of the invention, by using the optical element, the long and thick protruding section or the L-shaped member can be eliminated. Further, since the light emitting section, the optical element, and the external resonator can be disposed and fixed on the base plate from the same directions, it is superior in workability in the manufacturing process, thus the cycle time of the manufacturing process can be reduced. Thus, the cost reduction can be realized while simplifying the device configuration, and further, downsizing can also be realized.

### BRIEF DESCRIPTION OF THE DRAWINGS

The invention will now be described with reference to the accompanying drawings, wherein like numbers refer to like elements.

FIG. 1 includes a plan view and a side view showing a light source device according to a first embodiment.

FIG. 2 is a cross-sectional view along the II-II line shown in FIG. 1.

FIG. 3 is a cross-sectional view showing a light source device according to a second embodiment.

FIG. 4 is a graphic chart showing characteristics of polarization-dependent optical films according to the first and the second embodiments.

FIG. 5 is a diagram showing an image display device according to a third embodiment.

FIG. 6 is a diagram showing an image display device according to a fourth embodiment.

FIG. 7 is a diagram showing a past light source device.

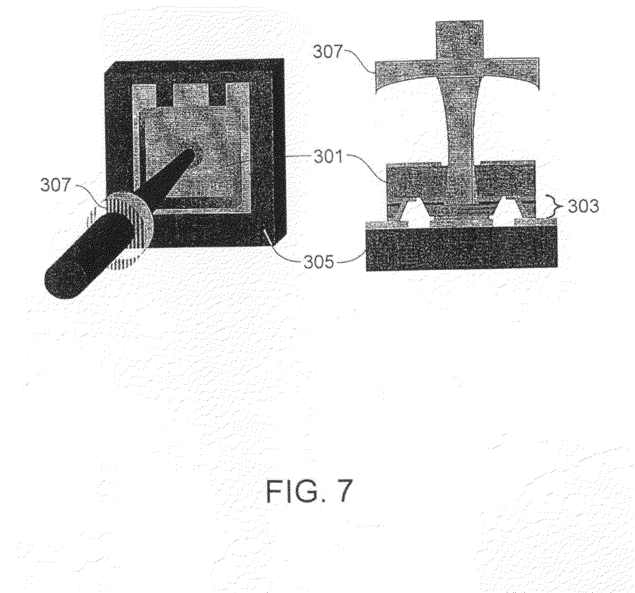

### DESCRIPTION OF EXEMPLARY EMBODIMENTS

Embodiments of the invention will hereinafter be described with reference to the accompanying drawings.

### First Embodiment

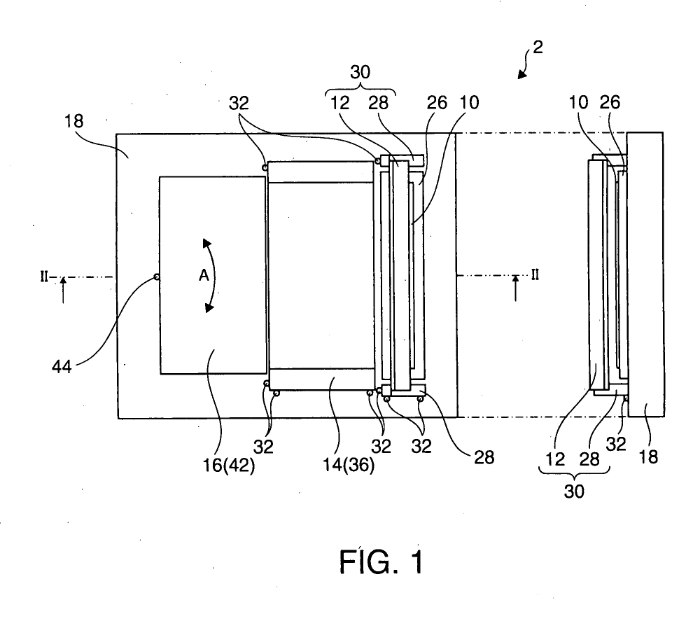

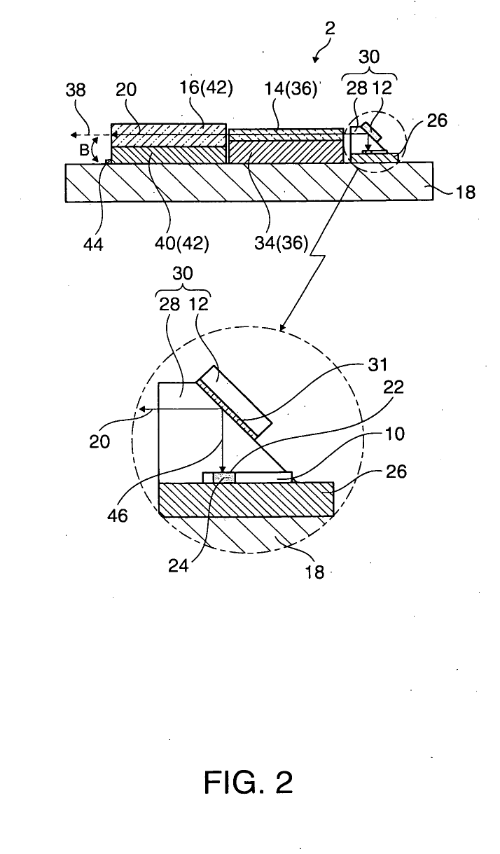

FIG. 1 includes a plan view and a side view showing a light source device according to a first embodiment. FIG. 2 is a cross-sectional view along the II-II line shown in FIG. 1. A light source device 2 according to the present embodiment, as shown in FIG. 1, includes a light emitting section 10, a reflection mirror 12 as an optical element, a wavelength conversion element 14, an external resonator 16, and a base plate 18.

### A. Function of Light Source Device

Firstly, the function of the light source device 2 will be explained with reference to FIG. 2.

The light emitting section 10 has at least one light emitting element (a surface emitting semiconductor laser) 24, which emits a laser beam 20 substantially perpendicular to a light emitting surface 22. Although the beam emitted from the light emitting element 24 in the initial state has a broad light emitting distribution with a peak around a specific wavelength (a fundamental wavelength), it will turn out to be the laser beam 20 with a sharp peak around the fundamental wavelength by causing the laser oscillation with the external resonator 16. The laser beam 20 emitted from the light emitting element 24 enters the wavelength conversion element 14 via the reflection mirror 12 described below.

The wavelength conversion element 14 is a nonlinear optical element disposed on a light path of the laser beam 20 formed between the reflection mirror 12 and the external resonator 16, and for converting the wavelength of the incident laser beam 20 into a specific wavelength (a conversion wavelength). For example, if the wavelength conversion element 14 is for converting the wavelength of the incident laser beam 20 into a wavelength a half as large as the original wavelength, the wavelength conversion element 14 converts the laser beam 20 with a wavelength of 1064 nm into one with a wavelength of 532 nm and emits it. It should be noted that the conversion efficiency of the wavelength conversion element 14 is in the range of about 30 through 50%, and accordingly, the whole of the laser beam 20 emitted from the light emitting element 24 is not necessarily converted into the conversion wavelength. Further, the wavelength conversion efficiency of the wavelength conversion element 14 has a nonlinear characteristic, in which the higher the intensity of the laser beam entering the wavelength conversion element 14 is, the more the conversion efficiency improved, for example. The wavelength conversion element 14 can be formed, for example, of a polarization inversion device using a nonlinear optical crystal. The laser beam 20 emitted from the wavelength conversion element 14 enters the external resonator 16.

The external resonator 16 is disposed on the light path of the laser beam 20 emitted form the light emitting element 24 via the wavelength conversion element 14, and has a function of selecting the beam with the same wavelength as the fundamental wavelength, and of returning about 98 through 99% thereof to the light emitting element 24. The selection characteristic has a vary narrow band, and accordingly, it can be thought that only the light with a wavelength substantially equal to the fundamental wavelength is selectively reflected.

The beam not converted into the conversion wavelength out of the laser beam emitted from the wavelength conversion element 14, namely the beam emitted from the wavelength conversion element 14 while keeping the fundamental wavelength thereof is reflected by the external resonator 16, and is returned to the light emitting element 24 via the wavelength conversion element 14 and the reflective mirror 12 again. The beam with the fundamental wavelength returned to the light emitting element 24 is reflected inside the light emitting element 24, and then emitted again from the light emitting element 24. By thus reciprocating the beam with the fundamental wavelength between the light emitting element 24 and the external resonator 16, the beam with the fundamental wavelength is amplified, thus the laser beam 20 with a narrow band (namely, the laser beam having a sharp peak around the fundamental wavelength) can be obtained. In other words, the external resonator 16 is provided with a function of causing the narrow band laser-oscillation of the light emitting element 24.

On the other hand, the laser beam 38, which is the laser beam emitted from the wavelength conversion element 14 and converted to have the conversion wavelength, is transmitted through the external resonator 16 and emitted from the light source device 2 as the laser beam 38.

It should be noted that the external resonator 16 has a volume phase grating formed inside a light conductive substrate, and has a configuration of providing a number of Bragg layers disposed along the light path although not shown in the drawings. As the substrate, alkali boro-aluminosilicate glass made mainly of SiO₂ is used, for example.

### B. Structure of Light Source Device

Then, the structure of the light source device 2 will be explained with reference to the FIGS. 1 and 2.

In the light source device 2 of the present embodiment, the light emitting section 10, the wavelength conversion element 14, and the external resonator 16 are fixed on a base plate 18. Further, the reflection mirror 12 for changing the proceeding direction of the laser beam 20 is disposed between the light emitting section 10 and the wavelength conversion element 14.

The light emitting section 10 is fixed on the base plate 18 while being supported by the supporting section 26, as shown in FIG. 2.

The reflection mirror 12 is disposed on the light path of the laser beam 20 emitted from the light emitting element 24. The reflection mirror 12 has a function of folding the laser beam 20 emitted from the light emitting section 10 to change the proceeding direction thereof. Specifically, the reflection mirror is disposed so that the laser beam 20 enters at an angle of about 45 degrees, and changes the proceeding direction of the laser beam 20 entering the reflection mirror 12 by about 90 degrees. As the reflection mirror 12, known configurations such as a mirror finished metal, a configuration in which a metal reflection film made, for example, of aluminum is deposited on a substrate made, for example, of glass, ceramics, or resin, or further a configuration in which a transparent plate made, for example, of glass is stacked on the metal reflection film can be adopted. The reflection mirror 12 and the spacer section 28 are bonded using an adhesive or the like to form a mirror assembly 30. Thus, it becomes easy to dispose and fix the light emitting section 10, the reflection mirror 12, and the external resonator 16 on the base plate 18. Further, it becomes possible to realize the effective change in the proceeding direction of the laser beam at a low cost.

The surface of the reflection mirror 12 on which the laser beams 20, 46 are reflected is provided with a polarization-dependent optical film 31. The polarization-dependent optical film 31 is formed to have a characteristic that the reflectance of one (e.g., the P polarized light beam) of the linear polarized light beams (the P polarized light beam and the S polarized light beam) substantially perpendicular to each other and included in the laser beams 20, 46 is higher than the reflectance of the other (e.g., the S polarized light) thereof at a predetermined incident angle. In this case, the reflectance of the polarization-dependent optical film 31 represents the ratio of the laser beam emitted to the wavelength conversion element 14 to the laser beam entering from the light emitting section 10. The polarization-dependent optical film 31 is formed of a dielectric multilayer film. The dielectric multilayer film can be formed, for example, of SiO₂, ZrO₂, or TiO₂ layer using CVD, and the thickness of each of the layers forming the multilayer film, the material, and the number of layers are optimized in accordance with the required characteristic. Thus, the laser beam aligned in the polarization direction can be obtained, and accordingly, the efficiency of the light can be improved when the light source is used in combination with the polarization controlling device such as a liquid crystal device. Further, it is arranged that the polarization direction of the polarization-dependent optical film 31 is substantially the same as the polarization direction of the wavelength conversion element 14. In the present embodiment, the polarization direction of the wavelength conversion element 14 is the vertical direction in FIG. 2, the polarization-dependent optical film 31 is formed to have higher reflectance for the P polarized light than the reflectance for the S polarized light.

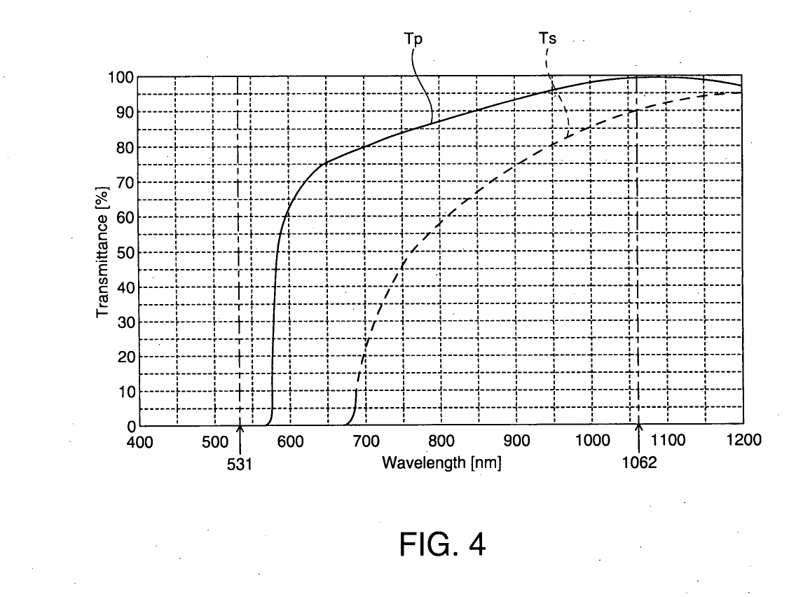

FIG. 4 is a graphic chart showing the characteristics of the polarization-dependent optical film 31 according to the first embodiment. The horizontal axis represents the wavelength of the incident light to the polarization-dependent optical film 31. The vertical axis represents the transmittance of the linear polarized light (the P polarized light Tp and the S polarized light Ts) included in the incident light to the polarization-dependent optical film 31. As shown in FIG. 4, the polarization-dependent optical film 31 is arranged to have a transmittance varied between when the P polarized light Tp is transmitted through the polarization-dependent optical film 31 and when the S polarized light Ts is transmitted through the polarization-dependent optical film 31. For example, the transmittance for the fundamental wave of the laser beam with the wavelength of around 1062 nm is arranged to be higher in the P polarized light Tp than in the S polarized light Ts. Thus, by arranging the polarization direction of the wavelength conversion element 14 to be substantially the same as the polarization direction of the P polarized light Tp, the laser oscillation is caused only in the polarized light with the polarized direction in which the wavelength conversion element 14 has high conversion efficiency, thereby improving the conversion efficiency of the wavelength conversion element 14.

Further, the polarization-dependent optical film 31 is arranged to have transmittance of zero for the laser beam with a wavelength of around 531 nm. The laser beam with the wavelength around this point is reflected by the polarization-dependent optical film 31. In the present embodiment, the polarization-dependent optical film 31 is formed to have the characteristic and the angle to reflect the laser beam towards the light emitting element 24. It should be noted that the polarization-dependent optical film 31 can also be formed to have the characteristic and the angle for reflecting the laser beam towards the wavelength conversion element 14.

The wavelength conversion element 14 is disposed on the light path of the laser beam 20 between the reflection mirror 12 and the external resonator 16. The wavelength conversion element 14 is positioned on the base plate 18 using a positioning section 32 (see FIG. 1) and fixed. As the wavelength conversion element 14, nonlinear optical crystal can be used, for example.

The wavelength conversion element 14 is a nonlinear optical element for converting the wavelength of the incident laser beam into substantially a half of the original wavelength, and accordingly, converts the wavelength of the laser beam 20. For example, when the laser beam 20 with a wavelength of 1064 nm enters the wavelength conversion element 14, the wavelength conversion element 14 emits a laser beam with a wavelength of 532 nm. The wavelength conversion efficiency of the wavelength conversion element 14 has a nonlinear characteristic, in which the higher the intensity of the laser beam entering the wavelength conversion element 14 is, the more the conversion efficiency improved, for example. Further, the conversion efficiency of the wavelength conversion element 14 is in a range of about 30 through 50%. In other words, the whole of the laser beam 20 emitted from the light emitting section 10 is not necessarily converted into the laser beam with a predetermined wavelength.

The wavelength conversion element 14 and a wavelength conversion element holder 34 are bonded using an adhesive or the like to form a wavelength conversion element assembly 36. Inside the wavelength conversion element holder 34, there is disposed a thermal control section (not shown) for keeping the wavelength conversion element 14 at an appropriate temperature. Specifically, the thermal control section is composed mainly of a heat source such as a peltiert element or a heater, and a thermal detector such as a thermistor, a platinum resistive element, or a thermoelectric couple. Thus, in the configuration for performing the wavelength conversion, by the external resonator 16 folding the light beam before the wavelength conversion to be recursively transmitted through the wavelength conversion element 14, the wavelength conversion can be performed without any loss, thus the conversion efficiency in the wavelength conversion element 14 can be improved.

The external resonator 16 is disposed on the light path of the laser beam 20 emitted from the light emitting element 24. The external resonator 16 selects the beam having the same wavelength as that of the laser beam 20 and returns about 98 through 99% thereof to the light emitting element 24, thereby functioning as the external resonator for causing the narrow band laser oscillation in the light emitting element 24. In this case, 1 through 2% of the laser beam power between the light emitting element 24 and the external resonator 16 is transmitted through the external resonator 16, and can be used as the laser beam.

Further, the external resonator 16 is provided with a wavelength range having high transmittance to transmit the laser beam 38 converted in the wavelength by the wavelength conversion element 14 into a half the wavelength of the laser beam 20. Therefore, the laser beam 38 can also used as the laser beam. It should be noted here that the laser beam 46 reflected by the external resonator 16 and proceeding in the direction returning to the light emitting element 24 has the same wavelength as the laser beam 20, and accordingly, the laser beam 46 is also converted to have a wavelength a half the original wavelength when passing through the wavelength conversion element 14.

The external resonator 16 has a volume phase grating formed inside a light conductive substrate, and has a configuration of providing a number of Bragg layers disposed along the light path although not shown in the drawings. As the substrate, alkali boro-aluminosilicate glass made mainly, for example, of SiO₂ is used, for example. Since the external resonator 16 is well known in the art, detailed explanations will be omitted here. It should be noted that although the external resonator 16 having the volume phase grating formed inside the light conductive substrate is used in the present embodiment, besides the volume phase grating, the external resonator composed of a mirror and a band-pass filter can also be used.

The external resonator 16 and an external resonator holder 40 are bonded using an adhesive or the like to form an external resonator assembly 42. The external resonator assembly 42 can be adjusted in two postures indicated by the arrow A (see FIG. 1) and the arrow B (see FIG. 2) to appropriately adjusting the direction (an amount of light) of the laser beam 46 reflected by the external resonator 16 and returned to the light emitting element 24 via the wavelength conversion element 14, The external resonator assembly 42 is positioned by one positioning section 44 for allowing the adjustment in the two postures indicated by the arrows A and B. The positioning section 44 is fixed with an adhesive after the two postures of the external, resonator assembly 42 has been adjusted with a robot or the like.

The base sheet 18 has a flat mounting surface on which a support, section 26, the mirror assembly 30, the wavelength conversion element assembly 36, and the external resonator assembly 42 are disposed and fixed. The surface of the base plate 18 on which the light emitting section 10 is disposed and fixed is required to have flatness with high accuracy, Since the part of the base plate 18 on which the wavelength conversion element 14 and the external resonator 16 are disposed can be processed simultaneously with the plane for the light emitting section 10, the mounting section of the base plate 18 for the wavelength conversion element 14 and the external resonator 16 are also finished with the flatness with high accuracy. The material of the base plate 18 is made of copper with a high thermal conductivity. Alternatively, the material of the base plate 18 is configured using a thermal conductive material for conducting neat. As the thermal conductive material, a metal member such as copper, brass, stainless steel, aluminum, indium, gold, silver, molybdenum, magnesium, nickel, or iron, diamond, or a member including at least one of the preceding materials can be used.

On the base plate 18, the light emitting section 10, the reflection mirror 12, the wavelength conversion element 14, and the external resonator 16 are disposed and fixed. The base plate 18 is provided with the positioning sections 32, 44 for positioning the elements at predetermined positions with respect to the light, emitting element 24 of the light emitting section 10. The base plate 18 has the positioning sections 32, 44 used for positioning, which are disposed on the basis of the light emitting element 24 of the light emitting section 10. On the base plate 18, there are disposed and. fixed the reflection mirror 12 and the wavelength conversion element 14 positioned using the positioning section 32. On the base plate 18, there is disposed and fixed the external resonator 16 positioned using the positioning section 44. The positioning sections 32, 44 are pins. Thus, the effective positioning can easily be realized. Further, it becomes possible to realize the effective positioning at a low cost.

By disposing each of the assemblies 30, 36, and 42 on the base plate 18 while positioning by the pin, and then fixing it with an adhesive or the like, the light source devices 2 is completed.

According to the present embodiment, by using the optical, element, the holding members for holding the external resonator and the wavelength conversion element in the laser beam emission direction of the light emitting element can be eliminated. Further, since the light emitting section, the optical element, and the external resonator can be disposed and fixed on the base plate from the same directions, it is superior in workability in the manufacturing process, thus the cycle time of the manufacturing process can be reduced. Thus, the cost reduction can be realized while simplifying the device configuration, and further, downsizing can also be realized.

### Second Embodiment

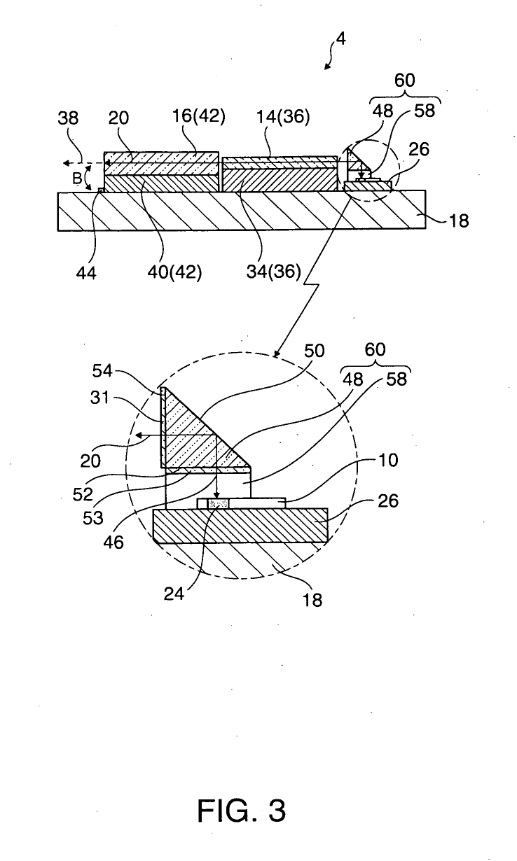

FIG. 3 is a cross-sectional view showing a light source device according to a second embodiment. It should be noted that the same parts as in the first embodiment are denoted with the same reference numerals, and the duplicated explanations will be omitted. In the present embodiment, the light source device 4 includes a prism 48 as the optical element. As the prism 48, for example, a known element made of a translucent material having a higher refractive index than the ambient air, such as glass or transparent resin can be adopted. Thus, it becomes possible to realize the effective change in the proceeding direction of the laser beam at a low cost.

The prism 48 is a rectangular prism having a cross-section of an isosceles right triangle. A laser reflection surface of the prism 48 including the long side 50 of the isosceles right triangle cross-section reflects the laser beams 20, 46 perpendicularly entering the surface of the prism 48 including the rest of the sides 52, 54. By using the prism 48, a highly accurate reflection angle of the laser reflection surface can easily be obtained. Thus, it becomes easy to dispose and fix the light emitting section, the optical element, and the external resonator on the base plate. It should be noted that the laser reflection surface of the prism 48 including the long side 50 can be provided with an optical film for reflecting the laser beam.

The surface of the prism 48 including the side 52 of the rest of the sides of the isosceles right triangle cross-section is disposed and fixed on the base plate 18 via a spacer section 58. The surface on which the spacer section 58 of the prism 48 is disposed is provided with a reflection reducing film 53 for reducing the reflection of the laser beams 20, 46 when the laser beams 20, 46 emitted or reflected from the light emitting element 24 enter the prism 48. The reflection reducing film 53 is, for example, an antireflection coating (AR coating). The AR coating is formed to have a characteristic and an angle capable of preventing reflection of the outside light on the entrance surface by coating two or more kinds of thin films with different refractive indexes on the surface of the prism 48 on which the spacer section 58 is disposed. Thus, by reducing the reflection of the laser beams 20, 46 on the surface of the prism 48 existing adjacent to the light emitting element 24, on which the spacer 58 is disposed, it is possible to reduce the adverse influence of the laser beams 20, 46 to the light emitting element 24, and to obtain stable laser oscillation by the light emitting element 24 and the external resonator 16. In addition, the reflection reducing film 53 can be a silica coating or an AR panel. The silica coating is obtained by depositing fine silica on the reflection reducing surface to form a fine concavo-convex pattern, thereby diffusely reflecting the outside light, and can be realized at a low cost. The AR panel is a type of adhering a particular reflection reducing film on the reflection reducing surface.

On the surface of the prism 48 including the side 54 through which the laser beams 20, 46 are transmitted, there is provided the polarization-dependent optical film 31. It should be noted that the polarization-dependent optical film 31 can be provided to the laser reflection surface of the prism 48 including the long side 50 on which the laser beams 20, 46 are reflected. Further, in the case in which the polarization-dependent optical film 31 is provided to the surface of the prism 48 including the side 54 of the isosceles right triangle, the polarization-dependent optical film 31 can further include the wavelength separation function of reflecting the laser beam towards the external resonator 16 again, the laser beam being obtained by wavelength-converting the laser beam 46, which is reflected by the external resonator 16, while passing through the wavelength conversion element 14. Since the surface of the prism 48 facing to the wavelength conversion element 14 is provided with the polarization-dependent optical film 31 including the wavelength separation function of reflecting the laser beam obtained by performing the wavelength conversion on the laser beam 46 so as to have a half wavelength thereof, the wavelength-converted laser beam can be taken out passing through the wavelength conversion element 14 and the external resonator 16 without returning the laser beam to the light emitting element 24. The wavelength-converted laser beam can be prevented from being absorbed by the light emitting element 24, thus the wavelength-converted laser beam can efficiently be taken out form the light source device 4. The prism 48 and the spacer section 58 are bonded with each other using an adhesive or the like to form a prism assembly 60. As other parts of the configuration, the content explained in the first embodiment can be applied. It is possible that the wavelength separation function is not included in the polarization-dependent optical film 31, but an optical film including the wavelength separation function is separately provided on the surface of the prism 48 including the side 54.

FIG. 4 is a graphic chart showing the characteristics of the polarization-dependent optical film 31 according to the second embodiment. The horizontal axis represents the wavelength of the incident light to the polarization-dependent optical film 31. The vertical axis represents the transmittance of the linear polarized light (the P polarized light Tp and the S polarized light Ts) included in the incident light to the polarization-dependent optical film 31. In this case, the transmittance of the polarization-dependent optical film 31 represents the ratio of the laser beam emitted to the wavelength conversion element 14 to the laser beam entering from the light emitting section 10. As shown in FIG. 4, the polarization-dependent optical film 31 is arranged to have a transmittance varied between when the P polarized light Tp is transmitted through the polarization-dependent optical film 31 and when the S polarized light Ts is transmitted through the polarization-dependent optical film 31. For example, the transmittance for the fundamental wave of the laser beam with the wavelength of around 1062 nm is arranged to be higher in the P polarized light Tp than in the S polarized light Ts. In the present embodiment, the polarization direction of the wavelength conversion element 14 is arranged to be substantially the same as the polarization direction of the P polarized light Tp, laser oscillation having high intensity in the polarized light with the polarized direction in which the wavelength conversion element 14 has high conversion efficiency is caused, thereby improving the conversion efficiency of the wavelength conversion element 14,

Further, the polarization-dependent optical film 31 is arranged to have transmittance of zero for the laser beam with a wavelength of around 531 nm. The laser beam with the wavelength around this point is reflected by the polarization-dependent optical film 31. Thus, the polarization-dependent optical film 31 is provided with the wavelength separation function.

According to the present embodiment, by using the optical element, the holding members for holding the external resonator and the wavelength conversion element in the laser beam emission direction of the light emitting element can be eliminated. Further, since the light emitting section, the optical element, and the external resonator can be disposed and fixed on the base plate from the same directions, it is superior in workability in the manufacturing process, thus the cycle time of the manufacturing process can be reduced. Thus, the cost reduction can be realized while simplifying the device configuration, and further, downsizing can also be realized. Further, the wavelength-converted laser beam can be prevented from being absorbed by the light emitting element, thus the wavelength-converted laser beam can efficiently be taken out form the light source device.

### Third Embodiment

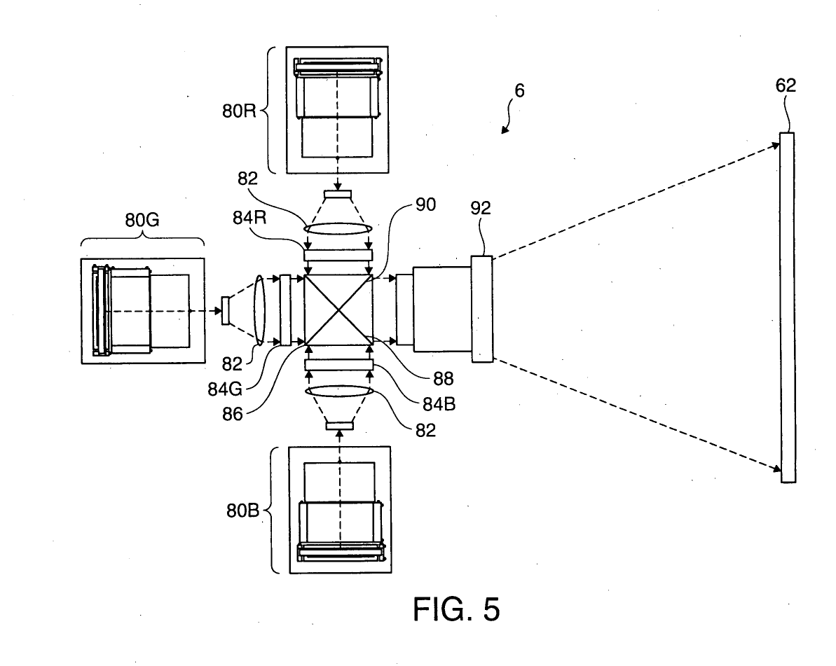

FIG. 5 is a diagram showing an image display device according to a third embodiment. In the present embodiment, an image display device 6 equipped with the light source device 2 according to the first embodiment described above will be explained. It should be noted that in FIG. 5, a chassis for forming the image display device 6 is omitted for the sake of simplification. The image display device 6 according to the present embodiment is a front projection projector, which supplies the screen 62 with light for allowing the viewer to appreciate an image by viewing the light reflected on the screen 62. The explanations duplicated with the first embodiment will be omitted. The image display device 6 includes a red laser source (a light source device) 80R for emitting red light, a green laser source (a light source device) 80G for emitting green light, and a blue laser source (a light source device) 803 for emitting blue light, each having a similar configuration to that of the light source device 2 (see FIG. 1). The image display device 6 displays an image using light beams from the respective color laser sources 80R, 80G, and 80B.

The red laser source 80R supplies the red light. The field lens 82 parallelizes the red light from the red laser source 80R, and make the red light enter the red light spatial light modulation device 84R. The red light spatial light modulation device 84R is a transmissive liquid crystal display device for modulating the red light in accordance with an image signal. The red light modulated by the red light spatial light modulation device 84R enters a cross-dichroic prism 86 as a color composition optical system.

The green laser source 80G supplies the green light. The field lens 82 parallelizes the green light from the green laser source 80G, and make the green light enter the green light spatial light modulation device 84G. The green light spatial light modulation device 84G is a transmissive liquid crystal display device for modulating the green light in accordance with an image signal. The green light modulated by the green light spatial light modulation device 84G enters the cross-dichroic prism 86 from a different side from the red light.

The blue laser source 80B supplies the blue light. The field lens 82 parallelizes the blue light from the blue laser source 80B, and make the blue light enter the blue light spatial light modulation device 84B. The blue light spatial light modulation device 84B is a transmissive liquid crystal display device for modulating the blue light in accordance with an image signal, The blue light modulated by the blue light spatial light modulation device 84B enters the cross-dichroic prism 86 from a different side from both the red light and the green light.

The cross-dichroic prism 86 is formed by bonding four rectangular prisms together, and provided with two dichroic films 88, 90 disposed on the inside surfaces so as to be substantially perpendicular to each other. The first dichroic film 88 reflects the red light, and transmits the green light and the blue light. The second dichroic film 90 reflects the blue light, and transmits the red light and the green light. The cross-dichroic prism 86 combines the red light, the green light, and the blue light entering in the respective directions and emits the combined light towards a projection lens 92. The projection lens 92 projects the light combined by the dichroic prism 86 towards the screen 62. The projector can be a so called rear projector, which supplies one of the surfaces of the screen with light and allows the viewer to appreciate an image by viewing the light emitted from the other surface of the screen. Further, the spatial light modulation device is not limited to the case of using the transmissive liquid crystal display device, but a reflective liquid crystal display device (a liquid crystal on silicon, LCOS for short), a digital micromirror device (DMD), a grating light valve (GLV), and so on can be used as the spatial light modulation device.

According to the present embodiment, by using the optical element, the holding members for holding the external resonator and the wavelength conversion element in the laser beam emission direction of the light emitting element can be eliminated. Further, since the light emitting section, the optical element, and the external resonator can be disposed and fixed on the base plate from the same directions, it is superior in workability in the manufacturing process, thus the cycle time of the manufacturing process can be reduced. Thus, the cost reduction can be realized while simplifying the device configuration, and further, downsizing can also be realized.

### Fourth Embodiment

Further, the light source devices 2, 4 according to the first, and the second embodiments can be applied to a scanning image display device.

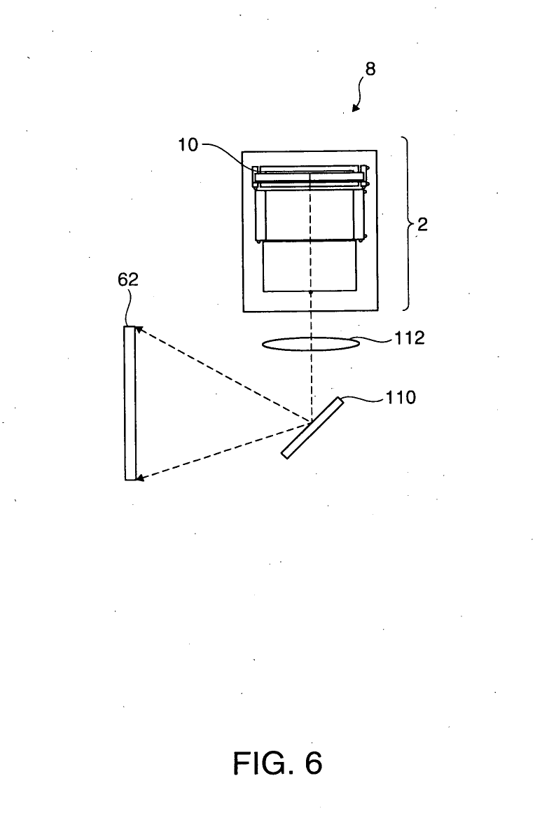

FIG. 6 is a diagram showing an image display device according to a fourth embodiment. In the present embodiment, an image display device 8 equipped with the light source device 2 according to the first embodiment described above will be explained. The image display device 8 according to the present embodiment is provided with the light source device 2 according to the first embodiment, an MEMS mirror (a scanning section) 110 for scanning the screen 62 with the light emitted from the light source device 2, and a condenser lens 112 for collecting the light emitted from the light source device 2 on the MEMS mirror 110. The light emitted from the light source 2 is led so as to scan on the screen 62 in the horizontal direction and the vertical direction by-moving the MEMS mirror 110. In the case of displaying a color image, it is possible to configure the plurality of light emitting elements 24 (see FIG. 2), which forms the light emitting section 10, by a combination of the light emitting elements 24 having peak wavelengths corresponding to red, green, and blue, respectively.

According to the present embodiment, by using the optical element, the holding members for holding the external resonator and the wavelength conversion element in the laser beam emission direction of the light emitting element can be eliminated. Further, since the light emitting section, the optical element, and the external resonator can be disposed and fixed on the base plate from the same directions, it is superior in workability in the manufacturing process, thus the cycle time of the manufacturing process can be reduced. Thus, the cost reduction can be realized while simplifying the device configuration, and further, downsizing can also be realized.

It should be noted that although in the present embodiment described above the wavelength conversion element 14 is used for converting the incident laser beam 20 to have a specific wavelength (the conversion wavelength), and the laser beam 38 with the conversion wavelength is used, the present embodiment can be applied to the light source device in which the wavelength conversion element 14 is not used. In this case, about 1 through 2% of the laser beam having the basic wavelength and transmitted through the external resonator (with the reflectance of about 98 through 99%) is used as the output light.

In the embodiment described above, although the reflection mirror 12 is disposed so that the laser beam 20 enters with an incident angle of about 45 degrees, thus the proceeding direction of the laser beam 20 entering the reflection mirror 12 is changed as much as about 90 degrees (in other words, the light path of the laser beam 20 is folded as much as about 90 degrees), the angles are nothing more than examples. The reflection mirror 12 is only required to be disposed so that the light path of the laser beam 20 is folded with an angle greater than zero and smaller than 180 degrees, and if the light emitting element 24, the reflection mirror 12, the wavelength conversion element 14, and the external resonator 16 are disposed on the light path of the laser beam 20 so as to allow the laser oscillation, the advantage of the embodiment of the invention can be achieved. It should be noted that in order for sufficiently obtaining the effect of downsizing, the reflection mirror 12 is preferably disposed so that the laser beam 20 enters with the incident angle no lower than 22.5 degree and no greater than 67.5 degree, and is preferably disposed so that the light path of the laser beam entering the reflection mirror 12 is folded with an angle no smaller than 77.5 degree and no greater than 112.5 degree. Further, in order for maximizing the effect of downsizing, it is preferable that, as in t n e embodiments described above, it is disposed so that the laser beam 20 enters at an incident angle of about 45 degrees, and is disposed so that the light path of the laser beam 20 entering the reflection mirror 12 is folded with an angle of about 90 degrees.

The entire disclosure of Japanese Patent Application Nos. 2006-284815, filed Oct. 19, 2006 and 2007-175878, filed Jul. 4, 2007 are expressly incorporated by reference herein.

What is claimed is:

1. A light source device comprising:
a light emitting section having at least one light emitting element for emitting a laser beam perpendicularly to an emission surface in laser oscillation;
an external resonator for selectively returning light with a specific wavelength to the light emitting element, thereby causing the laser oscillation of the light emitting element with the specific wavelength;
a base plate to which the light emitting section and the external resonator are fixed; and
an optical element disposed and fixed on a light path of the laser beam between the light emitting element and the external resonator and distantly from the surface of the light emitting element, and for changing a proceeding direction of the laser beam.

2. The light source device according to claim 1,
wherein the optical element changes the proceeding direction of the laser beam entering the optical element as much as about 90 degrees.

3. The light source device according to claim 2,
further comprising a wavelength conversion element on the light path of the laser beam between the optical element and the external resonator,
wherein the wavelength conversion element is disposed and fixed on the base plate and converts the wavelength of the laser beam which has passed through the optical element.

4. The light source device according to claim 3,
wherein the optical element is provided with a polarization-dependent optical film in the light path of the laser beam, the polarization-dependent optical film having a characteristic different in one of reflectance and transmittance representing a ratio of the laser beam emitted to the wavelength conversion element to the laser beam entering from the light emitting element between two polarization components if the laser beam having different polarization directions.

5. The light source device according to claim 4,
wherein the polarization direction in which one of the reflectance and the transmittance of the polarization-dependent optical film is higher is substantially the same as the polarization direction of the wave length element.

6. The light source device according to claim 1,
wherein the optical element is a mirror having a reflection surface for reflecting at least light with the wavelength of the laser beam.

7. The light source device according to claim 1,
wherein the optical element is a prism.

8. The light source device according to claim 7,
wherein the prism is a rectangular prism having a ross-section of an isosceles right triangle,
a surface of the rectangular prism including a long side of the isosceles right triangle cross-section is a reflection surface for reflecting laser beams entering surfaces of the rectangular prism respectively including the rest of the sides in a substantially perpendicular manner, and
a part of the surface of the rectangular prism including one of the rest of the sides is disposed and fixed to the base plate via a spacer section.

9. The light source device according to claim 8,
wherein a surface of the prism on which the spacer section is disposed is provided with a reflection reducing film for reducing reflection of the laser beam when the laser beam one of emitted and reflected by the light emitting element enters the prism.

10. The light source device according to claim 8,
wherein the polarization-dependent optical film is further provided with a wavelength separation function for reflecting a laser beam with a wavelength converted by the wavelength conversion element towards the external resonator when the laser beam with the wavelength converted by the wavelength conversion element enters from a side the external resonator in the case in which the polarization-dependent, optical film is provided to a surface of the rectangular prism including one of the rest of the sides other than the reflection surface and the spacer section disposing surface of the prism.

11. The light source device according to claim 1,
further comprising a positioning section for positioning the optical element and the external resonator with respect to the position of the light emitting element of the light emitting section.

12. The light source device according to claim 11,
wherein the positioning section is a pin.

13. An image display device comprising:
the light source device according to claim 1;
an optical modulation device for modulating light emitted from the light source device in accordance with an image signal; and
a projection device for projecting the image formed by the optical modulation device.

14. An image display device comprising:
the light source device according to claim 1; and
a scanning section for scanning a projection target surface with a laser beam emitted from the light source device.
